(19) United States
(12) Patent Application Publication
(10) Pub. No.: US 2011/0276746 A1
(43) Pub. Date: Nov. 10, 2011

(54) CACHING STORAGE ADAPTER ARCHITECTURE

(76) Inventors: Arvind Pruthi, Los Gatos, CA (US); Sandeep Karmarkar, Pune (IN); Kanishk Rastogi, Pune (IN); Shailesh Shiwalkar, Santa Clara, CA (US)

(21) Appl. No.: 13/101,534

(22) Filed: May 5, 2011

Related U.S. Application Data
(60) Provisional application No. 61/331,759, filed on May 5, 2010.

(51) Int. Cl. G06F 12/08

(52) U.S. Cl. 711/103; 711/E12.008; 711/E12.022

(57) ABSTRACT

An interface adapter includes a storage module including non-volatile random access memory (RAM), and a lookup module. The storage module is configured to store metadata in the non-volatile RAM. The metadata identifies data from an external storage device cached in a solid-state storage device. The lookup module is configured to receive a read request. The lookup module is further configured to, based on the metadata and in response to the read request, selectively provide cached data from the solid-state storage device or provide second data retrieved from the external storage device.

### CROSS-REFERENCE TO RELATED APPLICATIONS

This application claims the benefit of U.S. Provisional Application No. 61/331,759, filed on May 5, 2010. The disclosure of the above application is incorporated herein by reference in its entirety.

### FIELD

The present disclosure relates to caching host bus adapters and more particularly to caching host bus adapters using solid-state storage and non-volatile memory.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Referring now to FIG. 1A, a functional block diagram of an example of a computer architecture is shown. A processor 100 communicates with main memory 102 and a graphics processing module 104 via a northbridge module 106. The northbridge module 106 interfaces with a southbridge module 108, which provides access to peripherals. For example only, the southbridge module 108 interfaces with PCI (peripheral component interconnect) Express slots 110. In FIG. 1A, PCI Express cards 112-1 and 112-2 are installed in the PCI Express slots 110.

Referring now to FIG. 1B, an alternate computer architecture is shown. A processor 150 includes circuitry allowing the processor 150 to communicate directly with main memory 152 and a graphics processing module 154. The bus used to communicate between the processor 150 and the graphics processing module 154 may be, for example, AGP (accelerated graphics port) or PCI Express. A southbridge module 156 offers peripheral access to the processor 150. For example, the southbridge module 156 interfaces with PCI Express slots 110, in which PCI Express cards 112-1 and 112-2 are installed.

The southbridge modules 108 and 156 may interface with additional buses, such as Ethernet for networking, USB (universal serial bus) for external peripherals, and SATA (serial advanced technology attachment) for disk drives. The PCI Express cards 112 may implement additional interfaces. For example, the PCI Express card 112-1 may be a host bus adapter, which provides the processor 100 access to an interface such as SCSI (small computer system interface), eSATA (external SATA), or Fibre Channel.

### SUMMARY

An interface adapter includes a storage module including non-volatile random access memory (RAM), and a lookup module. The storage module is configured to store metadata in the non-volatile RAM. The metadata identifies data from an external storage device cached in a solid-state storage device. The lookup module is configured to receive a read request. The lookup module is further configured to, based on the metadata and in response to the read request, selectively provide cached data from the solid-state storage device or provide second data retrieved from the external storage device.

In other features, the storage module is further configured to maintain a write buffer in the non-volatile RAM. The second data is stored in the write buffer upon being retrieved from the external storage device. The second data is stored into the solid-state storage device after being stored in the write buffer. In further features, the interface adapter includes a buffer control module configured to determine when to store the second data from the write buffer into the solid-state storage device. The buffer control module is configured to store the second data into the solid-state storage device based upon a predetermined amount of data, including the second data, being present in the write buffer for storage in adjacent locations in the solid-state storage device.

In still further features, the interface adapter includes a cache eviction module configured to selectively allow selected data in the solid-state storage device to be overwritten. In other features, the lookup module is configured to, in response to the read request, construct a hit list of data present in the storage module, construct a miss list of data not present in the storage module, and send data requests to the external storage device according to the miss list.

A host bus adapter includes a solid-state storage device, non-volatile random access memory (RAM), and an execution module. The host bus adapter is configured to be installed in a computer. The execution module is configured to cache data from an external storage device in the solid-state storage device. The execution module is also configured to store metadata in the non-volatile RAM. The metadata indicates what data is cached in the solid-state storage device. The execution module is also configured to receive read requests from a central processor of the computer, and selectively respond to the read requests using the cached data from the solid-state storage device.

In other features, the execution module is configured to use a portion of the non-volatile RAM as a write buffer. The execution module is also configured to receive write requests from the central processor. The execution module is also configured to store write data corresponding to the write requests in the write buffer prior to storing the write data in the solid-state storage device. The execution module is also configured to, in response to the read requests, selectively provide data from the write buffer. The execution module is also configured to, when the metadata indicates that first data for one of the read requests is not stored in either the write buffer or the solid-state storage device, request the first data from the external storage device. The execution module is also configured to, once the first data is received from the external storage device, store the first data in the write buffer prior to storing the first data in the solid-state storage device.

A method of operating an interface adapter includes storing metadata in non-volatile random access memory (RAM) of the interface adapter. The metadata identifies data from an external storage device that is cached in a solid-state storage device. The method includes receiving a read request and, based on the metadata and in response to the read request, selectively providing cached data from the solid-state storage device or providing second data retrieved from the external storage device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1A is a functional block diagram of a computer architecture according to the prior art;

FIG. 1B is a functional block diagram of a computer architecture according to the prior art;

FIG. 2A is a functional block diagram of an example of a computing system according to the principles of the present disclosure;

FIG. 2B is a functional block diagram of an alternative example of a computing system according to the principles of the present disclosure;

FIG. 3A is a high level functional block diagram of an example of a caching storage adapter according to the principles of the present disclosure;

FIG. 3B is another high level block diagram of an example of a caching storage adapter according to the principles of the present disclosure;

FIG. 4 is a functional block diagram of an example of an implementation of a caching storage adapter according to the principles of the present disclosure;

FIG. 5 is a functional block diagram of an example of an implementation of a caching storage adapter according to the principles of the present disclosure;

FIG. 6 is a flowchart depicting an example of operation of a caching storage adapter according to the principles of the present disclosure; and

FIG. 7 is the flowchart depicting an example of operation of a caching storage adapter according to the principles of the present disclosure.

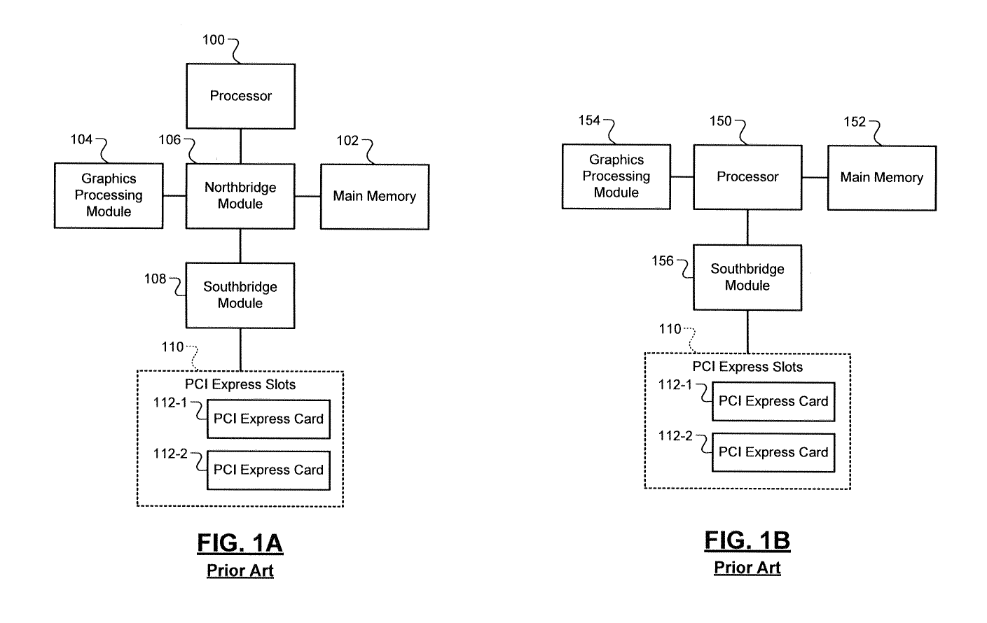

### DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

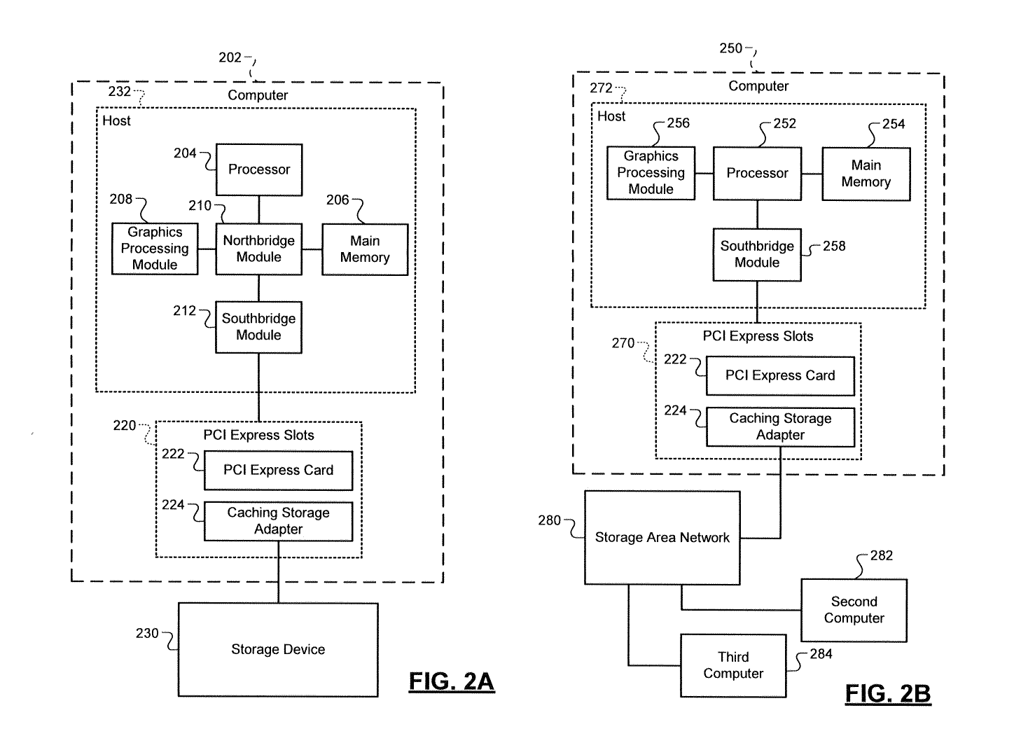

Referring now to FIG. 2A, an example of a computing system according to the principles of the present disclosure is shown. A computer 202 includes a processor 204, which interfaces with main memory 206 and a graphics processing module 208 using a northbridge module 210. The northbridge module 210 interfaces with a southbridge module 212, which provides the processor 204 with access to peripherals.

The southbridge module 212 interfaces with PCI Express slots 220. A PCI Express card 222 is installed in one of the PCI Express slots, and a caching storage adapter 224 is installed in another of the PCI Express slots 220. The caching storage adapter 224 interfaces with a storage device 230, and provides read and write access to the storage device 230 to the processor 204.

The processor 204, the main memory 206, the graphics processing module 208, the northbridge module 210, and the southbridge module 212 may be referred to collectively as a host 232. The caching storage adapter 224 can then be said to provide the host 232 with access to the storage device 230. The storage device 230 can include any type of mass storage. For example only, the storage device 230 can include one or more of a logical volume management (LVM) device, a virtual volume, a RAID (redundant array of inexpensive disks), a device identified by a LUN (logical unit number), an iSCSI (internet small computer system interface) LUN, an FC (Fibre Channel) LUN, an FCoE (Fibre Channel over Ethernet) LUN, DAS (direct attached storage), or a SAN (storage area network).

The host 232 issues commands to the storage device 230 via the caching storage adapter 224. Access requests, such as reads and writes, may be cached by the caching storage adapter 224. Control commands may be interpreted and executed by the caching storage adapter 224 and/or may be passed through to the storage device 230. In various implementations, the commands, sent from the host 232 to the caching storage adapter 224 may be in the form of SCSI commands. The caching storage adapter 224 may translate SCSI commands into suitable commands for the storage device 230.

The caching storage adapter 224 also translates between the PCI Express protocol and the protocol used to access the storage device 230. For example only, the storage device 230 may be accessed using Ethernet, eSATA (external serial advanced technology attachment), SAS (serial attached SCSI), SCSI (small computer systems interface), Infiniband, or Fibre Channel. The caching storage adapter 224 is depicted as being a PCI Express card. However, the principles of the present disclosure also apply to other interfaces. For example, the caching storage adapter 224 could use a USB (universal serial bus) interface such as USB 2.0 or USB 3.0. Alternatively, the caching storage adapter 224 could use a legacy interface such as PCI or PCI-X.

The caching storage adapter 224 can be implemented in a variety of form factors. For example, the caching storage adapter 224 could be implemented as an ExpressCard/34 or ExpressCard/54 form factor. The ExpressCard form factors may typically be used for portable computers. When implemented as an ExpressCard, the caching storage adapter 224 can be configured to use either PCI Express or USB.

Referring now to FIG. 2B, an alternative example of a computing system according to the principles of the present disclosure is shown. A computer 250 includes a processor 252, which interfaces with main memory 254 and a graphics processing module 256. The processor 252 interfaces with peripherals via a southbridge module 258. For example, the southbridge module 258 provides access to PCI Express slots 270. The PCI Express card 222 and the caching storage adapter 224 are shown installed in the PCI Express slots 270.

The processor 252, the main memory 254, the graphics processing module 256, and the southbridge module 258 can collectively be referred to as a host 272. The caching storage adapter 224 can be implemented or configured differently to take advantage of the different architecture of the host 272 compared to the host 232 of FIG. 2A. The host 232 or the host 272 may implement a target-mode driver, such as a SCSI target-mode driver, or an initiator-mode driver for communicating with the caching storage adapter 224.

In FIG. 2B, the caching storage adapter 224 is shown interfacing with a storage area network 280. The storage area network 280 includes one or more storage devices connected using networking components, which may include general computer networking components and/or storage-specific networking components. For example, the storage area network 280 may include Fibre Channel interconnects, Infiniband interconnects, Ethernet interconnects such as gigabit or 10 gigabit Ethernet interconnects, Fibre Channel over Ethernet interconnects, iSCSI interconnects, and ATA over Ethernet interconnects.

The storage area network 280 may also provide storage resources to additional computers. For example only, a second computer 282 and a third computer 284 are shown interfacing with the storage area network 280. In various implementations, the computer 250 may write data to storage resources of the storage area network 280 that will be accessed by the second computer 282 and/or the third computer 284.

In these situations, coherency of the written data may be improved by enabling a write-through mode of the caching storage adapter 224. In the write-through mode, the caching storage adapter 224 provides modified data to the storage area network 280 with as little delay as possible. In other modes, such a write-back mode, the caching storage adapter 224 may store modified data for longer periods of time before the modified data is sent back to the storage area network 280.

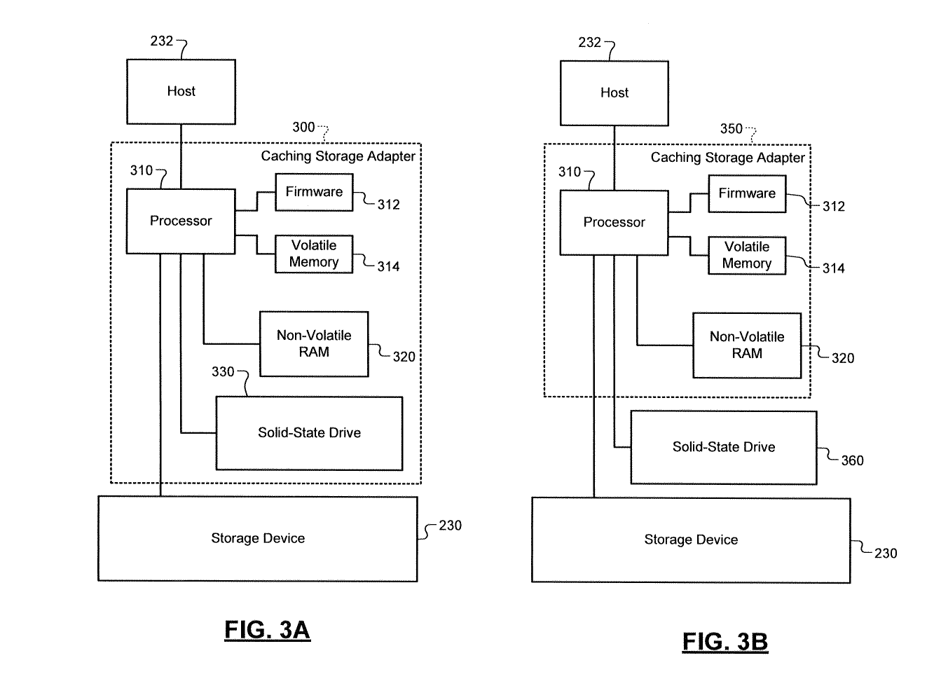

Referring now to FIG. 3A, a high level block diagram of an example of a caching storage adapter 300 is shown. For example only, the caching storage adapter 300 is shown interfacing with the host 232 and the storage device 230. The caching storage adapter 300 includes a processor 310, which may execute instructions from firmware 312, such as flash memory or read-only memory. The processor 310 may include internal temporary storage and may also store temporary instruction and data information in volatile memory 314.

The processor 310 interfaces with non-volatile RAM (random access memory) 320. The non-volatile RAM 320 may include volatile RAM, such as SRAM (Static Random Access Memory), DRAM (dynamic random access memory), or SDRAM (synchronous dynamic random access memory). The non-volatile RAM 320 includes components that cause the volatile RAM to have the properties of non-volatile RAM.

For example only, the non-volatile RAM 320 may include a backup battery source such as a battery, which may be a rechargeable battery. Non-volatile RAM 320 may also include a supercapacitor or any suitable type of electric double-layer capacitor, which provides power to maintain the contents of the non-volatile RAM 320. The non-volatile RAM 320 may therefore maintain data for only a limited period of time. Within that timeframe, backup power can be provided to the caching storage adapter 300. For example, an uninterruptable power supply or a backup generator can restore power to the caching storage adapter 300.

The processor 310 also interfaces with a solid-state drive 330. The solid-state drive 330 includes non-volatile memory such as flash memory. For example only, the flash memory may include single-level cell (SLC) storage cells, multi-level cell (MLC) storage cells, and/or Enterprise MLC storage cells, which are designed to exhibit a lower error rate than standard MLC storage cells. The storage cells may be NAND storage cells.

The processor 310 executes instructions that cache data from the storage device 230 in the solid-state drive 330. Information about what data is stored in the solid-state drive 330 is referred to as cache metadata. The cache metadata is stored in the non-volatile RAM 320. The cache metadata may also store additional attributes related to data stored in the solid-state drive, such as time of last access, number of accesses, and whether the data has been modified.

Write data provided by the host 232 is stored in the non-volatile RAM 320. The portion of the non-volatile RAM 320 used to store the write data is referred to as a write buffer. The processor 310 may designate a specified portion of the non-volatile RAM 320 to be the write buffer. The processor 310 may adjust this amount according to how much space is needed by the write buffer.

In various implementations, the processor 310 does not make any explicit designation of a write buffer within the non-volatile RAM 320. Instead, the processor 310 stores both cache metadata and write buffer data in the non-volatile RAM 320. When free space remaining in the non-volatile RAM 320 is limited, the amount of write buffer data may be reduced.

In various implementations, the processor 310 may store cache metadata at one end of the address range of the non-volatile RAM 320 and store the write buffer beginning at an opposite end of the address range of the non-volatile RAM 320. As more cache metadata and write buffer data is stored, the respective portions of the non-volatile RAM 320 expand to meet each other. The processor 310 may then be responsible for ensuring that there is no overlap between the write buffer data and the cache metadata.

The solid-state drive 330 may include storage cells as well as a storage controller. The storage controller may implement wear leveling algorithms, which dynamically assign data to various locations in the solid-state drive 330 in order to maximize usable life of the solid-state drive 330.

The solid-state drive 330 may be implemented by one or more controller integrated circuits, and one or more storage integrated circuits. These integrated circuits may be mounted to a primary circuit board of the caching storage adapter 300. Alternatively, the integrated circuits of the solid-state drive 330 may be implemented on a separate circuit board, which may be plugged in as a daughterboard to the caching storage adapter 300.

In other implementations, the solid-state drive 330 may be a fully-encased drive, which may be available at retail outlets for general use, such as for a primary hard drive of a laptop computer. In these implementations, the solid-state drive 330 may be mounted to the caching storage adapter 300 or may be connected via a flexible cable to the caching storage adapter 300.

For example only, the solid-state drive 330 may be mounted inside of a chassis that is common to the host 232 and the caching storage adapter 300 via SATA, eSATA, or SAS (serial attached SCSI) interfaces. The caching storage adapter 300 may be configured so that the solid-state drive 330 can be replaced to increase the size of the solid-state drive 330 and to replace the solid-state drive once its usable lifetime has expired.

The caching storage adapter 300 may provide connectivity to multiple solid-state drives including the solid-state drive 330. In various implementations, the capacity and performance characteristics of the solid-state drives may not need to be uniform. In various implementations, one of the solid-state drives, such as the solid-state drive 330 may be mounted to the caching storage adapter 300, while remaining ones of the solid-state drives are connected to the caching storage adapter 300 via cables.

Referring now to FIG. 3B, another high level functional block diagram of an implementation example of a caching storage adapter 350 is shown. The processor 310, the firmware 312, the volatile memory 314, and the non-volatile RAM 320 may be similar to that shown in FIG. 3A. In FIG. 3B, a solid-state drive 360 is pictured that is independent of the caching storage adapter 350. The solid-state drive 360 may therefore be mounted separately from the caching storage adapter 350, and may not even be within the same computer chassis as the caching storage adapter 350.

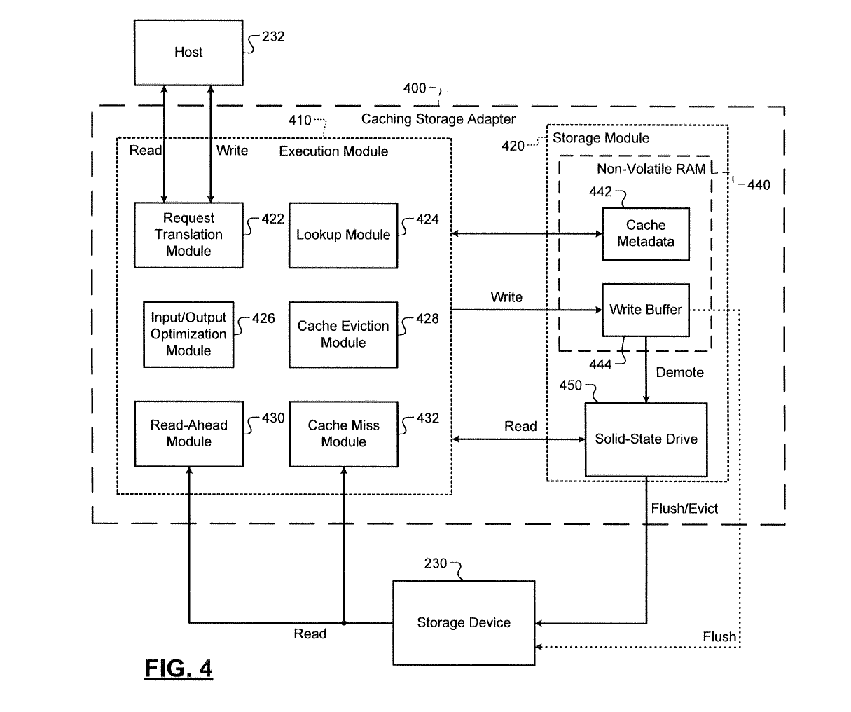

Referring now to FIG. 4, a functional block diagram of an example of an implementation of a caching storage adapter 400 is shown. The caching storage adapter 400 includes an execution module 410 and a storage module 420. The execution module 410 may include a processor and memory, where the processor executes instructions from the memory to perform various functions.

For example, the execution module 410 of FIG. 4 includes a request translation module 422, a lookup module 424, an input/output optimization module 426, a cache eviction module 428, a read-ahead module 430, and a cache miss module 432. The request translation module 422 translates commands from the host 232 into a form that can be used by remaining modules of the execution module 410. In addition, the request translation module 422 may translate commands from the host 232 into a form corresponding to the storage device 230.

For example only, the host 232 may provide SCSI commands to the request translation module 422. The request translation module 422 may then convert those commands into generic access commands and/or may convert those commands into a format corresponding to the storage device 230, such as Fibre Channel commands. In various implementations, the request translation module 422 may treat access commands, such as read commands and write commands, differently from control commands. For example, control commands may experience minimal or no translation and are subsequently passed on to the storage device 230.

The storage module 420 includes non-volatile RAM 440. Within the non-volatile RAM 440, the execution module 410 stores cache metadata 442 and uses some of the non-volatile RAM 440 as a write buffer 444. The execution module 410 may allocate a certain portion of the non-volatile RAM 440 for use as the write buffer 444. This allocation may be adjusted as necessary. Alternatively, the execution module 410 may simply store write buffer data in the non-volatile RAM 440, without having any particular section of the non-volatile RAM 440 set aside as the write buffer 444.

The storage module 420 also logically includes a solid-state drive 450, more generally referred to as a solid-state storage device. Although shown as part of the caching storage adapter 400, as described above the solid-state drive 450 may be detachably mounted to the caching storage adapter 400 or may be separate from the caching storage adapter 400 and connected via a cable. The solid-state drive 450 may be housed within a common chassis with the caching storage adapter 400 or may be outside of that chassis. The solid-state drive 450 may communicate with the remainder of the caching storage adapter 400 using SATA or eSATA.

The storage device 230 is referred to as an external storage device because the storage device 230 is both functionally and physically separate from the caching storage adapter 400. In many implementations, the storage device 230 will be in a separate chassis from the computer chassis that houses the caching storage adapter 400. In fact, the storage device 230 may not even be in the same server rack as the caching storage adapter 400 or even in the same room as the caching storage adapter 400.

Especially when the storage device 230 is implemented as a SAN (storage area network), the storage device 230 may not be confined to a single location. In various implementations, the implementation of the storage device 230, such as a SAN (storage area network), may hide the underlying complexity. The storage device 230 may therefore present an interface to the caching storage adapter 400 as if the storage device 230 were a single hardware volume, such as a single hard disk drive.

When the request translation module 422 receives a read request, addresses that are the target of the read request are provided to the lookup module 424. The lookup module 424 consults the cache metadata 442 to determine if the target addresses are currently cached, either in the write buffer 444 or in the solid-state drive 450. The lookup module 424 generates a hit list of target addresses that are cached, and generates a miss list of addresses that are not cached.

The lookup module 424 provides the miss list to the cache miss module 432. The cache miss module 432 will generally then request the target addresses from the storage device 230. Based on the size of the read request, the lookup module 424 may break up the read request into multiple lookup requests. For each lookup request, the lookup module 424 determines the hit list and the miss list based on the cache metadata 442.

The granularity of access to the storage device 230 may be different than the granularity of the access requests received from the host 232. For example, the host 232 may request a byte or word, while the storage device 230 may be accessed by block. In other words, each read or write may be performed as one or more blocks. For example only, each block may be four kilobytes in size. The cache miss module 432 may therefore request any blocks from the storage device 230 that will include target addresses from the miss list. This automatically takes advantage of spatial locality by reading a block from the storage device 230, which may include data before and/or after the target address.

In addition, the cache miss module 432 may be configured to request one or more subsequent blocks and/or one or more previous blocks from the storage device 230 at the same time to attempt to further leverage spatial locality. The read-ahead module 430 may attempt to predict what blocks will be accessed in the near future. The read-ahead module 430 then sends read requests for these blocks to the storage device 230. In various implementations, the read-ahead module 430 may wait to issue these read requests until the storage device 230 is finished servicing requests from the cache miss module 432.

The input/output optimization module 426 may track the accesses requested by the host 232 and the read requests sent to the storage device 230. The input/output optimization module 426 may be configured to dynamically calibrate temperature and locality information of the storage device 230. This calibration may be done on an area-by-area basis, where each area may be a predetermined number of blocks or may have a variable size based on determinations made by the input/output optimization module 426.

The term temperature refers to the amount of activity in a given area of the storage device 230. The locality information refers to the probability of accessing surrounding blocks after a given block has been accessed. The input/output optimization module 426 may invoke the read-ahead module 430 based on the likelihood of a block being accessed in the near future.

Read data provided by the storage device 230 is stored in the write buffer 444. The cache metadata 442 is updated to indicate that the data has been stored in the write buffer 444. The lookup module 424 can then respond to the read request via the request translation module 422 with the data from both the hit list and the miss list.

When the request translation module 422 receives a write request from the host 232, the data accompanying the write request is stored in the write buffer 444. This newly stored data is referred to as dirty, because it is different from the data stored in the storage device 230. Eventually, the modified data will be sent to the storage device 230. However, in a write-through mode, data received by the write buffer 444 is passed on to the storage device 230 with as little delay as possible. As described above, the write-through mode may be used when other systems are accessing the storage device 230, and therefore need access to the modified data.

Data in the write buffer 444 is written to the solid-state drive 450 because the capacity of the write buffer 444 is limited when compared with the solid-state drive 450. In various implementations, a write to the solid-state drive 450 requires writing to every element of an entire block of the solid-state drive 450. The block size of the solid-state drive 450 may be the same as or different than the block size of the storage device 230.

Solid-state drives generally degrade in performance and eventually become unusable as more and more writes/erases are performed. Therefore, data from the write buffer 444 may be written to the solid-state drive 450 once an entire block's worth of data would be written. This prevents the same block of the solid-state drive 450 from having to be re-written as each new piece of data is added to the block. In addition, changes to a single piece of data may be written to the write buffer multiple times before being demoted to the solid-state drive 450. Therefore, the storage cells in the solid-state drive 450 for that single piece of data only experience one write cycle, even though the data has changed multiple times.

The cache eviction module 428 determines when data in the solid-state drive 450 should no longer be cached. The data may actually be deleted from the solid-state drive 450, or in other implementations, the area in which that data was stored may be marked as free. Therefore, new cached data can be written over the evicted data. Prior to eviction, any dirty data, which has not been sent to the storage device 230, is flushed to the storage device 230. In addition, at periodic time or at other intervals dictated by various parameters, dirty data stored in the solid-state drive 450 is flushed to the storage device 230 so the storage device 230 reflects the most recent modifications. For example only, the solid-state drive 450 may flush data to the storage device 230 when more than a threshold amount of dirty data is stored in the solid-state drive 450.

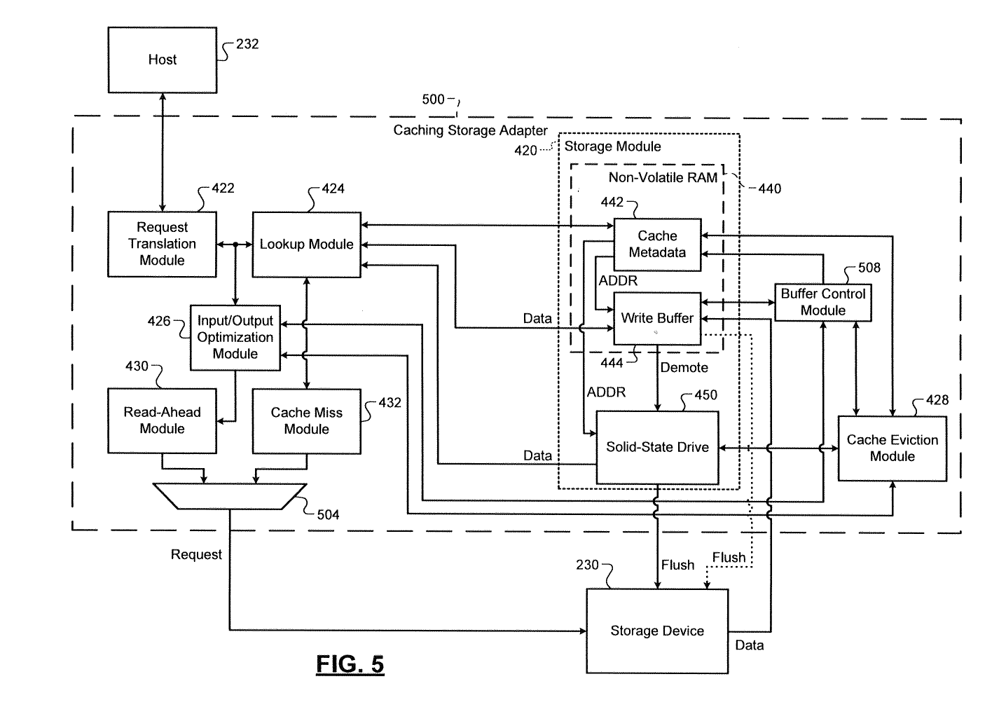

Referring now to FIG. 5, a functional block diagram of an example of an implementation of a caching storage adapter 500 is shown. Elements of the caching storage adapter 500 that may function similarly to elements described in FIG. 4 are labeled with the same reference numeral. In FIG. 5, some connections that may have been implicitly described in FIG. 4 are explicitly shown.

For example, the input/output optimization module 426 observes requests traveling between the request translation module 422 and the lookup module 424. In addition, the input/output optimization module 426 provides target addresses to the read-ahead module 430 to be requested from the storage device 230.

An arbiter 504 receives the requests from the read-ahead module 430 and the cache miss module 432 and sends these requests to the storage device 230. The arbiter 504 may prioritize requests from the cache miss module 432 over requests from the read-ahead module 430. The arbiter 504 may also combine requests, such as adjacent requests, to allow more efficient access to the storage device 230.

A buffer control module 508 determines when data from the write buffer 444 should be sent, or demoted, to the solid-state drive 450. When data is sent to the solid-state drive 450, the buffer control module 508 updates the cache metadata 442 to reflect the new storage location. The buffer control module 508 and the cache eviction module 428 may communicate with the input/output optimization module 426 to determine which data to demote to the solid-state drive 450 and which data to evict from the solid-state drive 450, respectively.

Because data read from the storage device 230 is stored in the write buffer 444, that data path is shown explicitly in FIG. 5. When the lookup module 424 processes a read request, the cache metadata 442 indicates locations in the write buffer 444 and/or the solid-state drive 450 where the requested data is stored. These addresses are provided to the write buffer 444 and/or the solid-state drive 450, which then provide the requested data to the lookup module 424. The lookup module 424 can then assemble the data and respond to the request from the host 232 via the request translation module 422.

When the lookup module 424 processes a write request, the data accompanying the write request is provided to the write buffer 444 for storage. The cache eviction module 428 updates the cache metadata 442 to indicate that the data previously stored in the solid-state drive 450 has been evicted and is therefore no longer cached. In various implementations, the cache eviction module 428 may verify with the buffer control module 508 that the write buffer 444 is not storing modified versions of the data that is about to be evicted.

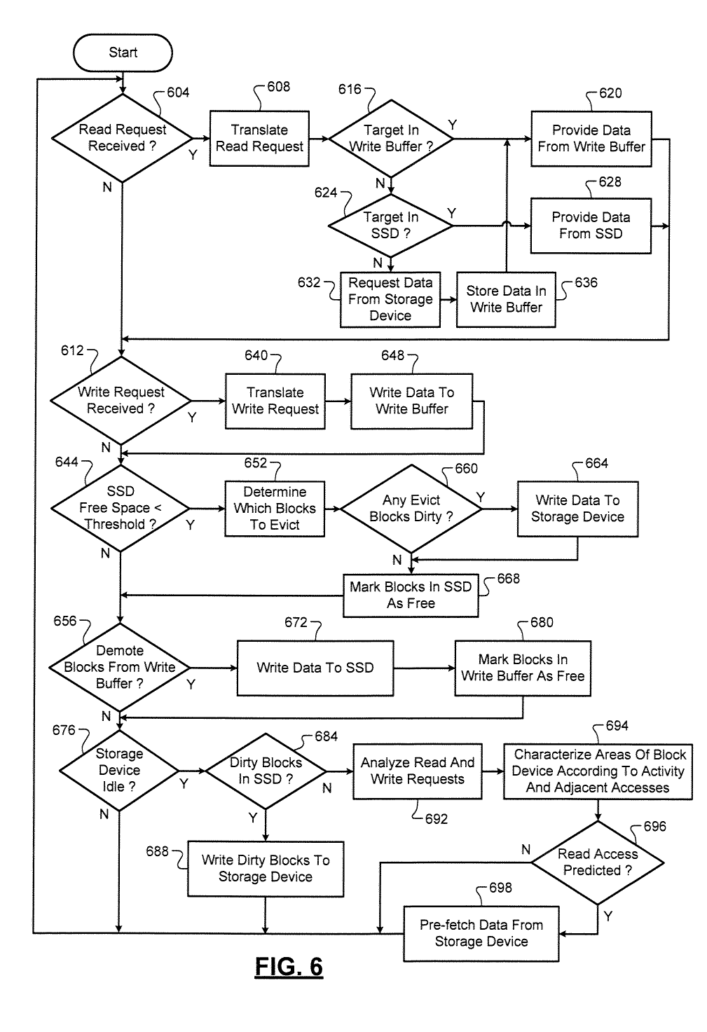

Referring now to FIG. 6, a flowchart presents an example of operation of a caching storage adapter according to the principles of the present disclosure. Control starts at 604, where if a read request is received, control transfers to 608; otherwise, control transfers to 612. At 608, the read request is translated and control continues at 616. At 616, if the target of the read request is in the write buffer, control transfers to 620; otherwise, control transfers to 624.

At 620, control provides the data requested by the read request from the write buffer and continues at 612. At 624, control determines whether the target is stored in the solid-state drive. If so, control transfers to 628; otherwise, control transfers to 632. At 628, control provides data from the solid-state drive in response to the read request and continues at 612. At 632, control requests data from the storage device and continues at 636. At 636, control stores data from the storage device in the write buffer and continues at 620.

At 612, control determines whether a write request has been received. If so, control transfers to 640; otherwise, control transfers to 644. At 640, control translates the write request and continues at 648. At 648, control writes the data associated with the write request to the write buffer and continues at 644. At 644, control determines whether free space in the solid-state drive is less than a threshold. If so, control transfers to 652; otherwise, control transfers to 656. At 652, in order to free space in the solid-state drive, control determines which blocks to evict and continues at 660.

At 660, if any of the blocks to evict are dirty, control transfers to 664; otherwise, control transfers to 668. At 664, control writes the dirty data to the storage device and continues at 668. At 668, controls marks the evicted blocks in the solid-state drive as free, meaning that they can be over-written with new data. In various implementations, if a request arrives for a block marked as free, the block may be re-characterized as in use and the data then used to service the request. Control continues at 656.

At 656, control determines whether blocks should be demoted from the write buffer. If so, control transfers to 672; otherwise, control transfers to 676. At 672, control writes the data from the write buffer to the solid-state drive and continues at 680. At 680, control marks the written blocks from the write buffer as free for use by other data and continues at 676.

At 676, control determines whether the storage device is idle. If so, control transfers to 684; otherwise, control returns to 604. For example, the storage device may be considered idle when not servicing write or read requests. At 684, control determines whether any blocks in the solid-state drive are dirty. If so, control transfers to 688; otherwise, control transfers to 692. At 688, control writes dirty blocks to the storage device and returns to 604. At 692, control analyzes read requests and write requests and continues at 694.

At 694, control characterizes areas of the storage device according to activity level and probability of adjacent blocks being requested after a given block has been requested. Control continues at 696, where control determines whether a future read access could be predicted based on the characterization of 694. If so, control transfers to 698; otherwise, control returns to 604. At 698, control pre-fetches data from the storage device at the address predicted by the characterization of 694. Control then returns to 604.

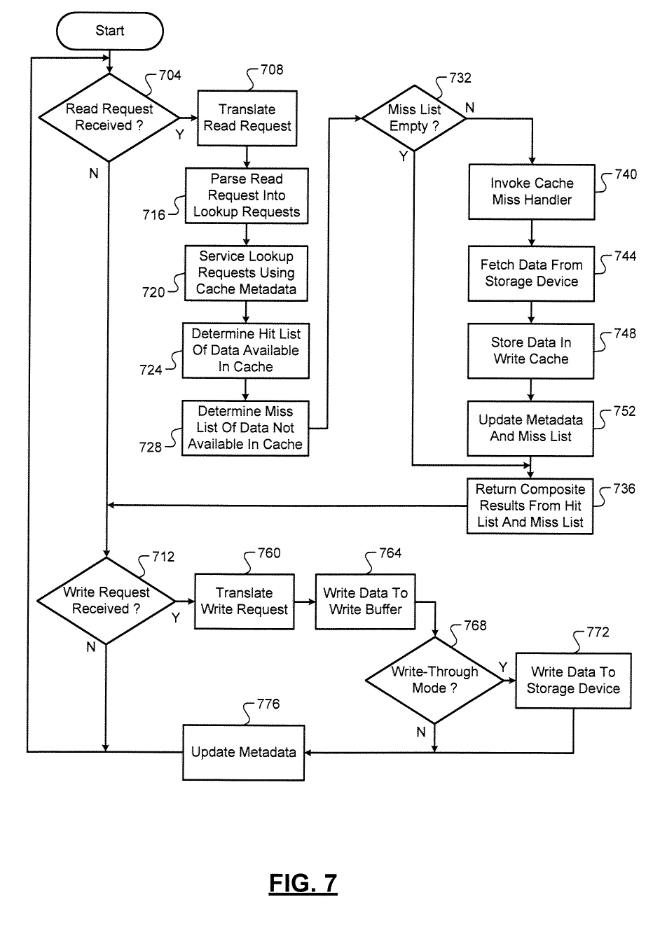

Referring now to FIG. 7, the flowchart depicts example operation of a caching storage adapter according to the principles of the present disclosure. Specifically, FIG. 7 focuses on examples of implementations of read and write request processing. Control begins at 704, where if a read request is received, control transfers to 708; otherwise, control transfers to 712. At 708, control translates the read request. Control continues at 716, where the read request is parsed into lookup requests based on the size of the read request.

Control continues at 720, where the lookup requests are serviced using cache metadata. Control continues at 724, where a hit list is created based on data that is available in the cache, whether in the write buffer or the solid-state drive. Control continues at 728, where a miss list is generated of data not available in the cache. Control continues at 732, where if the miss list is empty, control transfers to 736; otherwise, control transfers to 740.

At 740, control invokes a cache miss handler and provides the miss list to the cache miss handler. Control continues at 744, where data is fetched from the storage device according to the miss list. Control continues at 748, where data fetched from the storage device is stored in the write cache. Control continues at 752, where control updates the cache metadata and the miss list to indicate that the requested data is now stored in the write cache. Control continues at 736, where a response to the read request is returned including composite results corresponding to the hit list and the miss list. Control then continues at 712.

At 712, control determines whether a write request is received and if so, control transfers to 760; otherwise, control returns to 704. At 760, control translates the write request. Control continues at 764, where control writes the data corresponding to the write request to the write buffer. Control continues at 768, where if a write-through mode is active, control transfers to 772; otherwise, control transfers to 776. At 772, control writes the data to the storage device and continues at 776. At 776, control updates the cache metadata to indicate the newly stored write data and returns to 704.

Control is shown returning to 704 because the read requests and the write requests may be serviced using their own control loop, while other functions, such as demoting, evicting, input/output optimization, and flushing may be performed using other control loops. The other control loops may operate in parallel and may operate at a lower priority than the read and write request servicing.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. An interface adapter comprising:
a storage module including non-volatile random access memory (RAM), wherein the storage module is configured to store metadata in the non-volatile RAM, wherein the metadata identifies data from an external storage device cached in a solid-state storage device; and
a lookup module configured to receive a read request, and based on the metadata and in response to the read request, selectively provide cached data from the solid-state storage device or provide second data retrieved from the external storage device.

2. The interface adapter of claim 1, wherein:
the storage module is further configured to maintain a write buffer in the non-volatile RAM,
the second data is stored in the write buffer upon being retrieved from the external storage device, and
the second data is stored into the solid-state storage device after being stored in the write buffer.

3. The interface adapter of claim 2, wherein the lookup module is configured to selectively respond to the read request with data from the solid-state storage device or with data from the write buffer.

4. The interface adapter of claim 3, wherein the lookup module is configured to respond to the read request with the second data from the write buffer.

5. The interface adapter of claim 2, further comprising a buffer control module configured to determine when to store the second data from the write buffer into the solid-state storage device.

6. The interface adapter of claim 5, wherein the buffer control module is configured to store the second data into the solid-state storage device based upon a predetermined amount of data, including the second data, being present in the write buffer for storage in adjacent locations in the solid-state storage device.

7. The interface adapter of claim 2, wherein the lookup module is configured to receive a write request, and store write data associated with the write request in the write buffer.

8. The interface adapter of claim 7, wherein when a write-through mode is enabled, the write data is also provided to the external storage device.

9. The interface adapter of claim 1, further comprising a cache eviction module configured to selectively allow selected data in the solid-state storage device to be overwritten.

10. The interface adapter of claim 9, wherein the cache eviction module is configured to send modified portions of the selected data to the external storage device before the selected data is overwritten.

11. The interface adapter of claim 1, wherein the lookup module is configured to, in response to the read request, construct a hit list of data present in the storage module, construct a miss list of data not present in the storage module, and send data requests to the external storage device according to the miss list.

12. The interface adapter of claim 1, further comprising a translation module configured to translate a first bus request into the read request and translate a second bus request into a write request.

13. A host bus adapter configured to be installed in a computer, the host bus adapter comprising:
a solid-state storage device;
non-volatile random access memory (RAM); and
an execution module configured to
cache data from an external storage device in the solid-state storage device;
store metadata in the non-volatile RAM, wherein the metadata indicates what data is cached in the solid-state storage device;
receive read requests from a central processor of the computer; and
selectively respond to the read requests using the cached data from the solid-state storage device.

14. The host bus adapter of claim 13, wherein the execution module is configured to:
use a portion of the non-volatile RAM as a write buffer;
receive write requests from the central processor;
store write data corresponding to the write requests in the write buffer prior to storing the write data in the solid-state storage device;
in response to the read requests, selectively provide data from the write buffer;
when the metadata indicates that first data for one of the read requests is not stored in either the write buffer or the solid-state storage device, request the first data from the external storage device; and
once the first data is received from the external storage device, store the first data in the write buffer prior to storing the first data in the solid-state storage device.

15. A method of operating an interface adapter, the method comprising:
storing metadata in non-volatile random access memory (RAM) of the interface adapter, wherein the metadata identifies data from an external storage device that is cached in a solid-state storage device;
receiving a read request; and
based on the metadata and in response to the read request, selectively providing cached data from the solid-state storage device or providing second data retrieved from the external storage device.

16. The method of claim 15, further comprising:
maintaining a write buffer in the non-volatile RAM;
storing the second data in the write buffer upon retrieving the second data from the external storage device;
storing the second data into the solid-state storage device after storing the second data in the write buffer; and
selectively responding to the read request with the second data from the write buffer.

17. The method of claim 16, further comprising storing the second data into the solid-state storage device at a time based upon a predetermined amount of data, including the second data, being present in the write buffer for storage in adjacent locations in the solid-state storage device.

18. The method of claim 16, further comprising:
receiving a write request; and
storing write data associated with the write request in the write buffer,
wherein when a write-through mode is enabled, the write data is also provided to the external storage device.

19. The method of claim 15, further comprising:
selectively allowing selected data in the solid-state storage device to be overwritten; and
sending modified portions of the selected data to the external storage device before the selected data is overwritten.

20. The method of claim 15, further comprising:
in response to the read request, constructing a hit list of data present in the solid-state storage device;
in response to the read request, constructing a miss list of data not present in the solid-state storage device;
sending data requests to the external storage device according to the miss list; and
responding to the read request based on a combination of the hit list and the miss list.
